(19) United States
(12) Patent Application Publication
(10) Pub. No.: US 2026/0356417 A1
(43) Pub. Date: Nov. 12, 2026

(54) Transportation Vehicle, User Interface and Method for Interacting With a Steering Wheel of a Transportation Vehicle

(71) Applicant: Bayerische Motoren Werke Aktiengesellschaft, Muenchen (DE)

(72) Inventors: Joern FREYER, Muenchen (DE); Gernot SCHMIERER, Muenchen (DE)

(21) Appl. No.: 19/132,902

(22) PCT Filed: Oct. 12, 2023
(86) PCT No.: PCT/DE2023/100760

§ 371 Date: May 27, 2025

(30) Foreign Application Priority Data
Dec. 6, 2022 (DE) 10 2022 132 388.9

(51) Int. Cl. B62D 1/04; B60K 35/10

(52) U.S. Cl. CPC B62D 1/046; B60K 35/10; B60K 2360/1434; B60K 2360/1468; B60K 2360/782

(57) ABSTRACT

A method for interacting with a user interface of a transportation vehicle includes detecting a first gesture of a user by a touch-sensitive surface of the steering wheel of the transportation vehicle, generating a first reference for the first gesture using data of the surface, detecting a second gesture of the user by the touch-sensitive surface, generating a second reference for the second gesture using data of the surface, ascertaining a sufficient relatedness between the first reference and the second reference, in response thereto, predefining a model within which the first gesture and the second gesture at least partly lie, and triggering a function of the transportation vehicle by a third gesture if the third gesture corresponds to the model.

### BACKGROUND AND SUMMARY

The present disclosure relates to a transportation vehicle, a user interface and a method for interacting with a steering wheel of a transportation vehicle. In particular, the present disclosure relates to a more flexible design of user interfaces for cross transportation vehicles and temporal use by a user.

Modern transportation vehicles have a plurality of functions, which the occupant can access as required. Along with voice control and touchscreens, in particular gesture-based user input has proved itself as a user interface, which for example may be recorded by capacitive sensors. However, the user interfaces known in the prior art have a number of disadvantages: On the one hand, there is the problem of false activations, since different users make gestures in different ways. In other words, the orientation of for example a first swipe gesture in the case of a first user is sometimes considerably different than a second swipe gesture of a second user. In addition, a specified gesture can have a completely different connotation for a first client than for a second client. In other words, the execution of a swipe gesture for a view change is not sufficiently intuitive for a second client, and said client would rather bring about a view change through an alternative (swipe) gesture. Moreover, physical restrictions may also result in a user not being able to execute specified gestures or can only be carried out to a limited extent. For example, stiffened joints may hinder the random spreading of fingers/of the thumb by a user.

In addition, car sharing and leasing models have an uninterrupted popularity for clients/users. However, the frequent changing of vehicles in the prior art sometimes requires adapting the new transportation vehicles to the preferences of the user again.

The present disclosure addresses the problem of alleviating or eliminating the above identified disadvantages in connection with the prior art.

The aforementioned problem is solved according to the present disclosure by a method for interaction with a steering wheel of a transportation vehicle. The transportation vehicle can be embodied as a passenger vehicle, transporter, truck, motorcycle, aircraft and/or watercraft. The interaction can occur by a user within the transportation vehicle, said user therefore also being able to be referred to as occupant, driver, passenger or back-seat passenger. In a first step, a first gesture of a user is captured by a touch-sensitive surface of the steering wheel of the transportation vehicle. In other words, the gesture is (automatically) triggered by sensors or sensor technology and forwarded in data form. Subsequently, a first reference for the first gesture is generated using data of the surface. The touch-sensitive surface can be understood as a digitizer or touch-sensitive input surface. In other words, a data representation of the (first) gesture actually executed by the user. The resulting first reference can for example represent a time progression of a touch point between a finger of the user and the touch-sensitive surface. In a further step, a second gesture of the user is also captured by the (same) touch-sensitive surface of the steering wheel of the transportation vehicle. The second (swipe) gesture corresponds preferably in its fundamentals and its position to the touch-sensitive surface of the first gesture. In order to ensure a sufficient similarity, the user interface can output a corresponding instruction to the user, by which said user is prompted to repeat the first gesture with a slightly changed, second gesture which is assigned to a function call identical in its fundamentals. After the input, a second reference for the second gesture is automatically generated by the data of the touch-sensitive surface. Hence, actual trajectories or time progressions of touch points between tissue of the user and the touch-sensitive surface are represented in data form by the first and the second reference. Subsequently, a sufficient relatedness or identity of the first gesture and the second gesture is determined. In this connection, a distance and/or a difference and/or a spatial offset of the two gestures or components of the same corresponding to each other can be assessed, as to the extent to which the nature of the first gesture corresponds to the nature of the second gesture or the first gesture by the user should be executed similarly or identically to the second gesture. Further optional test steps will be discussed in the further course. In response to the determination of the sufficient relatedness, a model is subsequently predefined, within which the first gesture and the second gesture at least partially lie. This step could be understood as determining a threshold or a “corridor” for the first and second gestures in such a way that the generated model at least in a middle (main) section or core area of the gesture sufficiently identically envelops the first gesture and the second gesture or forms a type of “combined quantity”, which defines a threshold through the plane extension or the temporal progression of the first and second gesture, within which the first gesture and the second gesture are located. Through the model or the foregoing proposed middle area the first gesture and the second gesture can be delimited from other gestures, which hence can be defined for other function calls. The model could therefore also be understood as a virtual hose or a virtual belt (if applicable “smeared” over time), whose surface can be defined by the first gesture and the second gesture or at least can be influenced. In particular, positions lying between points of the first gesture and the second gesture corresponding to one another can likewise be determined as belonging to the model, while regions lying around a predefined dimension outside the route between points of the first gesture and the second gesture corresponding to each other are no longer associated with the model. Subsequently, a function of the transportation vehicle is triggered by a third gesture, which corresponds to the model or maintains a sufficient distance to the model. The user himself can have specified at an earlier time which function he would like to associate with the model determined like the foregoing. This can occur prior to the execution of the first and second gesture or after the execution of the first and second gesture or a reassignment of the (new) function of the transportation vehicle for the previously already defined and if applicable supplied with another function of the transportation vehicle. In this way the user can independently define a design of the first/second gesture or of the model that suits him and subsequently use it to trigger a function assigned by him to the suitable gesture. Hence, physical limitations for the gesture operation of a transportation vehicle are less relevant, the training and familiarization process can be significantly more intuitive and the definable gestures more comfortable for the individual user. Hence, user acceptance may be increased and faulty operations or error detection significantly reduced.

The present disclosure shows preferred further developments of the method according to the present disclosure.

Preferably, other training steps may be executed, in order to improve the model. This can occur in an initial training process, by having the user execute not just two gestures, but rather three, four, five or further gestures for the determination of the model. The user can be a client who has (just) acquired the transportation vehicle and would now like to customize. However, he can also be a client of a vehicle fleet/carsharing pool, who only uses the transportation vehicle on loan. The model formation can also occur during the use or after the occurrence of a predefined event and/or after the expiration of a predefined time since execution of the first gesture or of the second gesture. In this connection, a fourth gesture is captured by a sensor of the transportation vehicle and a fourth reference for the fourth gesture is recorded or triggered by the data of the sensor. These steps obviously correspond to those described above in connection with the first gesture and the second gesture, so that to avoid repetitions, reference is made to the above statements. Now the model can be updated in terms of the data of the fourth gesture or of the fourth reference, if necessary being specified or generalized.

All the steps in the present disclosure, which are not explicitly assigned to a human action or perception, can be understood as being executed automatically and/or by sensor technology. They can be executed by or with the aid of an evaluation unit (electronic controller, ECU), and/or by a transportation vehicle or its on-board electronics.

In corresponding manner other gestures for the triggering of a further (second) function may be predefined, in order to facilitate access to the second function for the user in manner according to the present disclosure. The same also applies for third functions, fourth functions and all further functions, which according to the prior art are known as being able to be triggered in logical manner by a surface of the steering wheel by the touch-sensitive surface.

Provided the first gesture and the second gesture have a sufficiently suitable relatedness, the transportation vehicle can output corresponding feedback to the user that the input was in order. If it turns out that the first gesture and the second gesture do not have a suitable relatedness to one another, corresponding negative feedback can be output to the user and if necessary prompt the user to execute one of the gestures or both gestures again. This can have an output in text, graphic in nature or acoustic in nature. Hence, it is possible to prevent the recorded gestures from being identical to one another and hence a future model detects too few correctly executed gestures of the user and on the other hand, it is possible to prevent a too “broad” model having too many different gestures assigned to one and the same function or too few other gestures having a sufficiently great distance from the present gesture.

The touch-sensitive surface can for example be arranged such on the steering wheel that, in the event of a comfortable/ergonomic grip on the three o'clock and nine o'clock position the user must only slightly bring the thumbs to an unnatural position in order to manipulate the touch-sensitive surface for gesture input. The exertion of force is lowered and the operator ergonomics profits.

The configuration of the gesture input, as described in detail above, can be started in response to the detection of a predefined user input. For example, to this end the user can select a menu item in a user menu or actuate a predefined voice input. A predefined driving situation or operation situation can also be detected, in response to which the configuration mode is started. For example, it may be detected that the user has reached a frustration threshold by performing a user input multiple times, in response to which obviously the function desired by said user was triggered. Such a situation can be determined by multiple repeated operation steps and/or by dismissive comments/noises/word messages of the user. In response thereto, it can be proposed according to the present disclosure to execute a separate first and/or second gesture in order to improve the user ergonomics from that point on.

One possible scenario for initializing the procedural steps according to the present disclosure can for example occur in addressing in response to a predefined driving situation and/or operation situation. For example, it can be established that the user is sitting in the vehicle for the first time. This can occur digitally or with the aid of face recognition/voice recognition. In principle, it is also possible to detect that this is the first user after transfer of the vehicle and that said user could need to enjoy the operator ergonomics provided according to the present disclosure. In response thereto the configuration mode for capturing the first (and second) gesture can automatically be offered.

The touch-sensitive surface can in particular have a substantially plane structure. In other words, the surface is smooth or slightly roughened, but has no structures which could be understood as bridges or other internal boundaries. In this way, the touch-sensitive surface can be supplied with functions substantially solely via software. It is also possible to react by software to user operation concepts developed later, without a new input matrix (digitizer) being necessary, or without having to be retrofitted with control buttons, wheels, controllers etc. executed in the hardware. The touch-sensitive surface is in particular located in a region of the steering wheel between an impact absorber and a steering wheel rim of the steering wheel. In particular, the touch-sensitive surface can be arranged at the level of the nine o'clock position and/or at the level of the three o'clock position. In this way, a particularly ergonomic handling by the thumbs occurs, when the steering wheel is gripped by the user in conventional manner.

Since the above-mentioned steps for developing the model can take a certain amount of time and the model can be consolidated/verified/corrected via a plurality of operating steps, the findings are associated with a considerable added value for the user and will be sorely missed after a vehicle change according to the prior art. Therefore, it is preferably proposed to represent the model by a data record (a file or similar) and for example to send wirelessly and/or by an internet mediated transmission to a second transportation vehicle, in which it can likewise be used. This only requires that the new transportation vehicle has a corresponding touch-sensitive surface in the steering wheel and is capable of importing the data record representing the model. Now all of the efforts undertaken by the user thus far to increase the ergonomics may be enjoyed in the new transportation vehicle. In this consideration, it is unimportant whether the model is ported or copied to the new transportation vehicle. In particular for the case that different transportation vehicles are assigned to the user (e.g., private vehicle fleet or commercial vehicle fleet/car sharing pool), it is also possible to cause the model to be kept up to date via all transportation vehicles assigned to the user and after optimization steps to always update all transportation vehicles with the most up to date model. The model can be stored in a central database of a vehicle manufacturer, a vehicle fleet manager or similar. A linking of a vehicle assigned to the user with his ID (account) kept in a (stationary) database is now sufficient to automatically always assign the latest model for the gesture operation to the transportation vehicle. Alternatively, or in addition to this, the model can also be kept locally in the transportation vehicle (if necessary along with further users of the models assigned to the transportation vehicle).

Even if within the scope of the above disclosure the gestures have always been illustrated as swipe gestures, the gestures may alternatively or in addition be designed as rotational gestures (circular track with one or more fingers) and/or two-dimensional gestures and/or static (long-press gestures) and/or finger-spread or finger together gestures. In other words, all gestures that may be triggered logically with a touch-sensitive surface according to the prior art may also be learned in a manner according to the present disclosure and stored as a model.

The function which the user may access with a method according to the present disclosure can for example be associated with a scroll- and/or view change function. Further possibilities are volume change functions, skip functions, change program functions, window regulator/roof window-/sunroof and/or panoramic roof and roof liner roller operating functions. In addition, an interior lighting intensity, interior lighting color, ambient light pattern and color, external signaling functions, seating comfort settings and accept/decline phone call functions can also be operated using models that can be learned according to the present disclosure.

According to a second aspect of the present disclosure, a user interface for a transportation vehicle is proposed, which has a data input, an evaluation unit and a data output. The evaluation unit is equipped by the data input to capture a first gesture of a user by a touch-sensitive surface of a steering wheel of the transportation vehicle. The captured gesture is illustrated by a first reference, just as a second gesture, which is illustrated in a second reference. By the two references,—assuming a sufficient relatedness or identity—a data model is generated, which can be saved by the data output. The first reference and the second reference lie at least partly within the model and fulfill the model per se. Moreover, by the data output a predefined function may be triggered, if a third gesture is determined by the data input, which sufficiently corresponds to the model. In this way, the user interface according to the present disclosure is obviously equipped to realize the features, feature combinations and the advantages arising therefrom in corresponding manner, such that, to avoid repetitions reference is made to the above statements.

According to a third aspect of the present disclosure, a transportation vehicle is proposed, which has a user interface according to the second mentioned aspect of the present disclosure. Expressed in a different way, the transportation vehicle has a steering wheel with a touch-sensitive surface, by which the transportation vehicle is capable of executing the steps of the method according to the present disclosure. Also in this respect, reference is made to the features, feature combinations and advantages of the above-described aspects.

Further details, features and advantages of the present disclosure arise from the following description and the figures.

### BRIEF DESCRIPTION OF THE DRAWINGS

FIG. 1 shows a detailed view of an exemplary embodiment of a user interface of an exemplary embodiment of a transportation vehicle in the execution of a method;

FIG. 2 shows an overview to illustrate a porting of a model of a transportation vehicle generated according to various embodiments to a further transportation vehicle; and

FIG. 3 shows a flow chart illustrating steps of an exemplary embodiment of a method for interaction with a steering wheel of a transportation vehicle according to various embodiments.

### DETAILED DESCRIPTION OF THE DRAWINGS

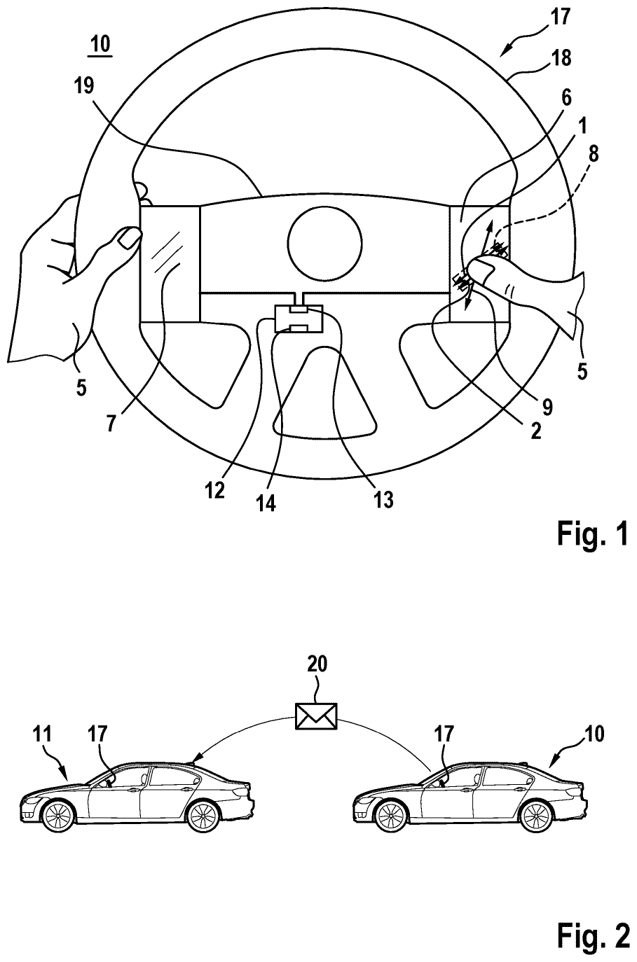

FIG. 1 shows a steering wheel 17 with a steering wheel rim 18 and an impact absorber 19, which a user 5 has gripped at the three o'clock position and the nine o'clock position, in order to steer the transportation vehicle 10. Between the steering wheel rim 18 and the impact absorber 19 touch-sensitive surfaces 6, 7 according to the present disclosure are arranged on both sides, which are linked by information technology to a data input 13 of an electronic controller as an evaluation unit 12. Via a data output 14, the evaluation unit 12 can store the gestures 1, 2 executed by the user 5, which are sufficiently similar, as model 8. The model 8 can be understood as a belt or hose, in which the gestures 1, 2 fit in as the first gesture and the second gesture. A fourth gesture 9 has a distance to the first gesture 1 and the second gesture 2 so great that it does not fit in the model 8. If the fourth gesture 9 should be executed within the scope of a configuration mode, in order to generate the model 8, a repetition is automatically requested or a feedback output to the user that the gesture 9 is not sufficiently related to the first and the second gesture 1, 2. On the other hand, the fourth gesture 9 can be supplied in a configuration mode for the triggering of an alternative function. To this end, an alternative (not shown) model would be generated in corresponding manner. In a user mode, the gesture 9 would not be assigned to the model 8 and the function assigned to it. This function would not be triggered. Only for the case that a model assigned to the further gesture 9 is stored, would a function assigned to this model be triggered by the fourth gesture 9.

FIG. 2 shows two transportation vehicles 10, 11, which have respective steering wheels 17 with touch-sensitive surfaces (not shown), as presented in connection with FIG. 1. After successful definition of a model (reference numeral 8 in FIG. 1) a wireless message 20 is sent from the first transportation vehicle 10 to the second transportation vehicle 11, by which the second transportation vehicle 11 is equipped to detect user gestures with the aid of the same model. If necessary, further developed models within the second transportation vehicle 11 can be provided in corresponding manner to the first transportation vehicle 10 or to further transportation vehicles (not shown).

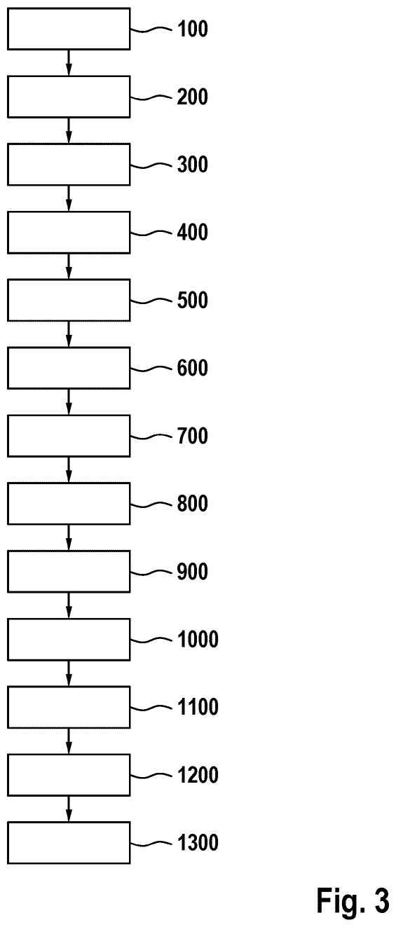

FIG. 3 shows steps of an exemplary embodiment of a method according to the present disclosure. In step 100 a predefined driving situation is detected, which permits a secure configuration of the user interface according to the present disclosure. This can for example be the first driving situation, which occurs according to requirements of a configuration of a user interface and no safety concerns regarding the distraction of the user can be detected. For example, the vehicle can be in a parked state. In step 200 therefore a configuration mode for capturing the first gesture for the creation of a model is automatically offered. In step 300 subsequently a predefined user input is detected and in response thereto the configuration mode for capturing the first gesture is started in step 400. In step 500 a first gesture of the user is now captured by a touch-sensitive surface of the steering wheel of the transportation vehicle and in step 600 a first reference representing the first gesture is generated by the data of the touch-sensitive surface. In step 700 in corresponding manner a second gesture of the user is captured by the touch-sensitive surface of the steering wheel of the transportation vehicle and in step 800 a reference assigned to the second gesture is generated and stored. In step 900 now a sufficient relatedness of the first reference and the second reference is determined and in response thereto in step 1000 a model is predefined, within which the first gesture and the second gesture at least partially lie. In other words, with the aid of the first reference and the second reference a validity quantity is defined, which decide for the detection of further gestures in a user mode whether the respective gesture corresponds to the model or not. In step 1100 subsequently a function of the transportation vehicle is triggered by a third gesture, provided the third gesture corresponds to the model. Otherwise, if applicable an error message is output, or—provided the third gesture corresponds to an alternative model-triggers the function assigned to the alternative model. In step 1200 the determined model is transferred in data form to another transportation vehicle, which is likewise equipped to execute the method according to the present disclosure. In step 1300 the data record for the detection of third gestures is likewise used in other transportation vehicles.

Hence, the interaction of a user can always be updated and made convenient with one or more vehicles, even after comparatively long service lives.

### LIST OF REFERENCE NUMERALS

1 first gesture
2 second gesture
5 user
6,7 touch-sensitive surface
8 model
9 fourth gesture
10,11 transportation vehicle
12 evaluation unit
13 data input
14 data output
17 steering wheel
18 steering wheel rim
19 impact absorber
20 wireless message
100 to 1300 procedural steps

1-12. (canceled)

13. A method for interaction with a steering wheel of a transportation vehicle comprising:
detecting a first gesture of a user by a touch-sensitive surface of the steering wheel of the transportation vehicle;
generating a first reference for the first gesture using data of the touch-sensitive surface;
detecting a second gesture of the user by the touch-sensitive surface of the steering wheel;
generating a second reference for the second gesture using data of the touch-sensitive surface;
ascertaining a sufficient relatedness between the first reference and the second reference;
predefining a model within which the first gesture and the second gesture at least partly lie; and
triggering a function of the transportation vehicle by a third gesture in response to the third gesture corresponding to the model.

14. The method according to claim 13, comprising:
automatically outputting feedback to the user regarding whether the first gesture and the second gesture have a suitable relatedness.

15. The method according to claim 13, wherein the touch-sensitive surface is arranged at a region on an impact absorber adjoining a steering wheel rim.

16. The method according to claim 13, comprising:
detecting a predefined user input; and
responsively starting a configuration mode for detecting the first gesture.

17. The method according to claim 13, comprising:
detecting a predefined driving situation and/or operating situation and/or vehicle situation; and
responsively automatically offering a configuration mode for detecting the first gesture.

18. The method according to claim 13,
wherein the touch-sensitive surface:
has a substantially planar structure, and/or
is arranged in a region of the steering wheel between an impact absorber and a steering wheel rim.

19. The method according to claim 13, comprising:
transferring a data record representing the model to another transportation vehicle, which has a corresponding touch-sensitive surface on a steering wheel thereof; and
using the data record to detect third gestures in the other transportation vehicle.

20. The method according to claim 13,
wherein the first gesture, the second gesture, and the third gesture comprise at least one of:
a swipe gesture;
a rotational gesture;
a two-dimensional gesture;
a long-press gesture; and/or
a finger-spread gesture.

21. The method according to claim 13,
wherein the function comprises at least one of:
a volume change function;
a skip function;
a change program function;
a scroll function;
a window regulator function;
a roof window function;
a sunroof or panoramic roof function;
a roof liner roller blind function;
interior lighting function;
exterior signaling function;
a seating comfort function; and/or
an accept or reject phone call function.

22. A user interface for a transportation vehicle, comprising:
a data input;
an evaluation unit; and
a data output,
wherein the evaluation unit, via the data input, is configured to:
detect a first gesture of a user by a touch-sensitive surface of a steering wheel of the transportation vehicle;
generate a first reference for the first gesture using data of the touch-sensitive surface;
detect a second gesture of the user by the touch-sensitive surface;
generate a second reference for the second gesture using data of the touch-sensitive surface;
ascertain a sufficient relatedness between the first reference and the second reference;
generate a model via the data output, within which the first gesture and the second gesture at least partly lie; and
trigger a predefined function by the data output, in response to a third gesture corresponding to the model.

23. The user interface according to claim 22,
wherein the evaluation unit is configured to:
automatically output feedback to the user regarding whether the first gesture and the second gesture have a suitable relatedness.

24. The user interface according to claim 22,
wherein the touch-sensitive surface is arranged at a region on an impact absorber adjoining a steering wheel rim.

25. The user interface according to claim 22,
wherein the evaluation unit is configured to:
detect a predefined user input; and
responsively start a configuration mode for detecting the first gesture.

26. The user interface according to claim 22,
wherein the evaluation unit is configured to:
detect a predefined driving situation and/or operating situation and/or vehicle situation; and
responsively automatically offer a configuration mode for detecting the first gesture.

27. The user interface according to claim 22,
wherein the touch-sensitive surface:
has a substantially planar structure, and/or
is arranged in a region of the steering wheel between an impact absorber and a steering wheel rim.

28. The user interface according to claim 22,
wherein the evaluation unit is configured to:
transfer a data record representing the model to another transportation vehicle,
which has a corresponding touch-sensitive surface on a steering wheel thereof,
wherein the other transportation vehicle uses the data record to detect third gestures in the other transportation vehicle.

29. The user interface according to claim 22,
wherein the first gesture, the second gesture, and the third gesture comprise at least one of:
a swipe gesture;
a rotational gesture;
a two-dimensional gesture;
a long-press gesture; and/or
a finger-spread gesture.

30. The user interface according to claim 22,
wherein the predefined function comprises at least one of:
a volume change function;
a skip function;
a change program function;
a scroll function;
a window regulator function;
a roof window function;
a sunroof or panoramic roof function;
a roof liner roller blind function;
interior lighting function;
exterior signaling function;
a seating comfort function; and/or
an accept or reject phone call function.

31. A transportation vehicle comprising:
the user interface according to claim 22.
